(19) United States
(12) Patent Application Publication
(10) Pub. No.: US 2023/0259872 A1
(43) Pub. Date: Aug. 17, 2023

(54) COGNITIVE ROUTE PLANNING USING METRIC-BASED COMBINATORIAL EVALUATION TECHNIQUES

(71) Applicant: International Business Machines Corporation, Armonk, NY (US)

(72) Inventors: Deng Xin Luo, Xian (CN); Xiang Yu Yang, Xi'an (CN); Yong Wang, Xi'an (CN); Ye Wang, Xian (CN); Zhong Fang Yuan, Xi'an (CN); Zhi Yong Jia, Xian (CN)

(73) Assignee: International Business Machines Corporation, Armonk, NY (US)

(21) Appl. No.: 17/671,263

(22) Filed: Feb. 14, 2022

(51) Int. Cl. G06Q 10/08

(52) U.S. Cl. CPC G06Q 10/08355

(57) ABSTRACT

An embodiment includes parsing geographical data into a path graph having a plurality of nodes and edges, and identifying first and second subsets of the nodes as source nodes and destination nodes, respectively. The embodiment generates path data for a candidate delivery route from a source node to a destination node and along an edge between the source and destination nodes. The embodiment processes the path data using first and second evaluation techniques based on respective metrics. The embodiment compares evaluation values from the evaluation techniques to evaluation values associated with another candidate delivery route, and selects the candidate delivery route as a finalized delivery route based on the comparison results. The embodiment then generates a route plan that includes the finalized delivery route.

### BACKGROUND

The present invention relates generally to a method, system, and computer program product for data processing. More particularly, the present invention relates to a method, system, and computer program product for cognitive route planning using metric-based combinatorial evaluation techniques.

Food distribution is a complex task, especially for sensitive food products that are perishable goods. A perishable good is any product in which quality deteriorates due to environmental conditions through time, such as meat and meat by-products, fish and seafood, dairy products, fruit and vegetables, flowers, pharmaceutical products, and chemicals. Perishable food products often travel vast distances from source to point of sale, which often involves one or more stops along the way for processing or distribution. All of this transportation, processing, and distribution can be very time consuming, which works against the freshness and quality of perishable food products that consumers desire.

Milk is an example of a perishable food product that undergoes considerable transportation and processing on the way to the market. Milk is collected at dairy farms using tanker trucks that deliver the milk to a dairy factory (also known as a processing facility or a dairy plant). The frequency of milk collection varies depending on a number of factors, such as the number of cows in the herd. For example, a relatively smaller dairy farm may have milk collected every other day, whereas a relatively larger dairy farm may have milk collected every day or several times per day.

### SUMMARY

The illustrative embodiments provide for cognitive route planning using metric-based combinatorial evaluation techniques. An embodiment includes parsing geographical data into a path graph by storing a plurality of nodes representative of respective locations and by storing a plurality of edges representative of respective vehicle routes between pairs of locations. The embodiment also includes identifying first and second subsets of the plurality of nodes using characteristic data associated with the nodes, where the first subset of the plurality of nodes are identified as source nodes that produce perishable food items and the second subset of the plurality of nodes are identified as destination nodes that process perishable food items. The embodiment also includes generating path data representative of a first path beginning at a first source node and ending at a first destination node, where the first path comprises a first edge connected between the first source node and the first destination node, and where the first path is a first candidate delivery route that includes loading a perishable food item at the first source node, traveling along the vehicle route represented by the first edge, and delivering the perishable food item at the first destination node. The embodiment also includes processing the path data using a plurality of evaluation techniques that result in a first set of evaluation values, where the plurality of evaluation techniques comprises a first evaluation technique based on a first optimization metric, a second evaluation techniques based on a second optimization metric, and a third evaluation technique based on a combination of the first and second evaluation techniques. The embodiment also includes comparing the first set of evaluation values to a second set of evaluation values of a second path associated with a second candidate delivery route that begins at the first source node. The embodiment also includes selecting the first path as a first finalized delivery route based on a result of the comparing of the first set of evaluation values to the second set of evaluation values. The embodiment also includes generating a route plan that includes a plurality of finalized delivery routes that provide for delivery of perishable food items from the source nodes to the destination nodes, the plurality of finalized delivery routes including the first finalized delivery route. Other embodiments of this aspect include corresponding computer systems, apparatus, and computer programs recorded on one or more computer storage devices, each configured to perform the actions of the embodiment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a cloud computing environment according to an embodiment of the present invention;

FIG. 2 depicts abstraction model layers according to an embodiment of the present invention;

FIG. 3 depicts a block diagram of an example service infrastructure that includes a distribution optimization system in accordance with an illustrative embodiment;

FIG. 4 depicts a block diagram of an example distribution optimization system in accordance with an illustrative embodiment;

FIG. 5 depicts an example of a path graph according to an embodiment;

FIG. 6 depicts a block diagram of an example evaluation metrics module in accordance with an illustrative embodiment;

FIG. 7 depicts a block diagram of an example evaluation metrics module in accordance with an illustrative embodiment;

FIG. 8 depicts a block diagram of an example historical path optimization module in accordance with an illustrative embodiment; and

FIG. 9 depicts a flowchart of an example process for cognitive route planning using metric-based combinatorial evaluation techniques in accordance with an illustrative embodiment.

### DETAILED DESCRIPTION

Food distributors are businesses that specialize in transporting food items between the various parts of the food industry, such as suppliers, manufacturers, warehousers, retailers, and end consumers. For example, food distributors may transport food items from a production facility (e.g., a farm or food processing facility) to a distribution center warehouse, where the food items are divided up and transported to different retainers. Alternatively, food distributors may transport food items from a production facility (e.g., a farm) to a food processing facility, where the food items are processed into different food items (e.g., wheat to bread) or otherwise prepared for sale (e.g., pasteurization and homogenization of milk).

Perishable food items are a particularly challenging category of food items for distributors. For example, perishable food items must be transported within a limited window of time. Also, many perishable food items must be transported in certain conditions, such as temperature and/or humidity levels, that conflict with conditions required for other food items, making it necessary to transport certain food items separately. These are examples of requirements for perishable food items that add to the complexity of delivery route planning for food distributors.

Many food distributors deliver food items from several sources to several destinations. For example, a food distributor may be responsible for transporting milk from several different dairy farms to several different dairy factories. Scheduling and planning the loading and transporting of milk from in such a network of multiple dairy farms and dairy factories is a very complex task. The dairy farms may be tens or hundreds of miles apart, may have varying pickup frequency requirements, and may produce different categories of dairy products that cannot be transported together. The milk factories may also be tens or hundreds of miles apart and/or tens or hundreds of miles from the dairy farms, and may have varying processing capacities and processing capabilities. The food distributor may have a variety of different types of vehicles with varying load capacities, capabilities, and efficiencies that affect the transport cost per unit of freight.

The challenge presented by all of these factors is further exacerbated by the ebb and flow of supply and demand for certain food products, variations in the production capacity of dairy farms, and variations in the capacity and capability of dairy factories, for example due to equipment failures, factory expansions, or equipment upgrades. In addition to all of these considerations, food distributors must also consider the perishable nature of the dairy products that limits the amount of time available to load, transport, and process the dairy products in order to deliver them to retailers while still at a level of freshness and quality expected by consumers.

All of these factors make it very difficult and time consuming for small to mid-size distributors to manually create delivery route plans and make it practically impossible for larger distributors to manually create delivery route plans. For distributors that do manually create delivery route plans, the process is generally dependent on a planning specialist who has a strong knowledge of the distributor's operations. The planning specialist must review incoming orders and group them for pickup and delivery routes. The planning specialist may use previous routes or may need to research maps to try to determine new routes for non-standard orders or new customers. Such manual route planning is very time consuming and rarely, if ever, results in an optimally efficient delivery route plan. Manual route planning is also susceptible to human error in numerous ways, such as transport conditions conflicts (e.g., loading food products that must be transported at different temperature ranges) or route problems (e.g., height or weight road restrictions).

These issues are among the many reasons that most food distributors have transitioned to route planning software that is capable of generating delivery route plans that are more efficient and can do so in much less time than the manual process. However, existing software applications still lack the ability to generate truly optimal delivery route plans. Distribution optimization is highly desirable for several reasons, such as satisfying demand, minimizing waste, improving profitability, and reducing unnecessary wear and tear on transportation vehicles.

Existing software applications generally attempt to improve the distribution of perishable goods by focusing on a subset of resources and constraints to try to simplify the problem. Such attempts generally require business personnel and modeling engineers to build an algorithm to improve the efficiency of distribution and loading of perishable food items. These algorithms are generally based on a mixed integer linear programming model. Powerful computing platforms are then used process the algorithm to search for a solution that will improve the efficiency of a distribution plan.

Thus, existing software and processes have several problems. For one, they rely on the availability of professional personnel to perform the roles of modeling engineers having relevant modeling experience and business knowledge. Also, the mixed integer linear programming model is highly complex, making it difficult and inefficient to solve the resulting algorithms. It is also very difficult to change the algorithms stemming from this application of the mixed integer linear programming model as conditions change in the distribution network.

Aspects of the present disclosure address the deficiencies described above by providing mechanisms (e.g., systems, methods, machine-readable media, etc.) that utilize a new advanced A-Star method to optimize distribution routes in the perishable food distribution industry. Exemplary embodiments use distribution transport information to construct a path graph, and apply an A-star algorithm to find an optimal path in the path graph. Exemplary embodiments also address the problems of short shelf life and isolated transportation of fresh products by applying new evaluation metrics involving supply consumption and vehicle use, respectively. In addition, exemplary embodiments introduce an improved hybrid computing A-star optimization algorithm that incorporates the use of evaluation functions based on task objectives.

In some embodiments, a cognitive route optimization process includes parsing geographical data into a path graph by storing a plurality of nodes representative of respective locations and by storing a plurality of edges representative of respective vehicle routes between pairs of locations. In some embodiments, the process fetches or receives characteristic data for routes and locations represented by the nodes and edges from one or more sources, for example from user input, a local and/or remote database, or public data sources such as public Application Programming Interface (API) that provides weather or traffic information. In some embodiments, once the data is collected, the process translates the data to a graph format.

In some embodiments, the process assembles the graph formatted data as a data structure assembled in chronological order with two fields—nodes and edges—that are arrays of node objects and edge objects. In some embodiments, the edges include data fields that identify a pair of nodes that the edge connects. In some embodiments, there are two types of nodes—source nodes and destination nodes—that may be distinguishable in various ways, such as data attributes or distinct classes.

In some embodiments, the process associates characteristic data with corresponding nodes and edges. In some embodiments, the nodes and edges have a data property that is used to store the associated characteristic data about the node/edge. In some embodiments, the characteristic data includes data that is relevant to generating and/or optimizing delivery routes. It will be appreciated that much of the characteristic data may be implementation-specific. However, as an example, in some embodiments, the characteristic data includes supplier characteristic data, processor characteristic data, and transport characteristic data.

In some embodiments, when the process identifies a node that corresponds with some characteristic data, the process associates the characteristic data with that node, and then identifies the node as a source node if the characteristic data is supplier characteristic data or as a destination node if the characteristic data is processor characteristic data. In some embodiments, the source nodes represent dairy farms and the characteristic data in the data property of the source nodes may include supplier characteristic data such as product categories (e.g., categories of perishable food) produced by the dairy farm and respective production levels, as well as location, hours of operation, point of contact information, and so on. In some embodiments, transport vehicles are provided by the dairy farms, and the data property includes supplier characteristic data about available vehicles, such as the number of vehicles, the respective load capacities, cost of operation (e.g., dollars per mile or per hour), etc.

In some such embodiments, the destination nodes represent dairy factories and the characteristic data in the data property of the destination nodes may include processor characteristic data such as product categories (e.g., categories of perishable food products) processed by the dairy factory, intake limits for the respective product categories, as well as location, hours of operation, point of contact information, and so on. In some such embodiments, the edges represent vehicle routes (i.e., roads, highways, etc.) and the characteristic data in the data property of the edges may include transport characteristic data such as travel distance, height and/or weight restrictions, tolls, steep grades, road construction or road closures, etc.

In the illustrated embodiment, the process is configured to determine evaluation metrics that provide bases for evaluation techniques used to select optimal delivery routes. It will be appreciated that the number and types of metrics may be highly implementation specific, for example depending on the goals of the implementation. As an example, in some embodiments, the following four metrics are used:
A. Minimize transport cost: transport cost=Σₖ₌₁^{K}Xᵢⱼₖ*Dᵢⱼ*Uᵢⱼ
B. Maximize factory demand satisfaction: Supply/Demand on a per-product-category basis
C. Maximize the extent of farm production utilization: Transport/Supply on a per-product-category basis
D. Minimize the number of vehicles used: Σₖ₌₁^{K} Vehicle on a per-category basis The above four metrics are sometimes referred to herein as metrics A, B, C, and D as designated above. In metrics A, B, C, and D, i represents a dairy farm, j represents a dairy factory, k represents a vehicle of K total vehicles, Dᵢⱼ represents a distance from dairy farm i to dairy factory j, Uᵢⱼ represents a unit transportation cost from dairy farm i to dairy factory j, and Xᵢⱼₖ represents tonnage transported from dairy farm i to dairy factory j using vehicle k. While four metrics are used in this embodiment, alternative embodiments may use more or fewer metrics.

In the illustrated embodiment, the process performs a graph traversal and path search algorithm on the path graph generated by the process to generate optimal delivery routes. In some embodiments, the process uses a new hybrid A-Star algorithm introduced herein.

The hybrid A-Star algorithm disclosed herein is a variation of the known A-Star algorithm, which is a best-first graph search algorithm that finds the least-cost path from a given initial node to one goal node (out of one or more possible goals). All possible paths from a start point to a destination point may be sequentially examined in order of increasing cost. Thus, A-star uses a distance-plus-cost heuristic function (usually denoted f(x)) to determine the order in which the search visits nodes in the tree. The distance-plus-cost heuristic may be a sum of two functions: the path-cost function, which is the cost from the starting node to the current node (usually denoted g(x)); and an admissible “heuristic estimate” of the distance to the goal (usually denoted h(x)).

The hybrid A-Star algorithm disclosed herein uses a heuristic estimate based on an evaluation cost that is determined using a plurality of evaluation techniques as indicated by expression (1) below.

$$For i in {2}^{n} - 1 : {h}_{i}^{n} = {\sum }_{s = n}^{target} {w}_{s} {f}_{i} \qquad ( 1 )$$

In expression (1), hᵢⁿ is the evaluation function ƒᵢ that contributes to the estimated cost, wₛ is a constant coefficient, and ƒᵢ is the corresponding evaluation function i. Note that each valid hᵢⁿ needs to meet production requirements, such as the constraints discussed below.

The hybrid A-Star algorithm starts at a source node and uses a plurality of evaluation techniques to evaluate multiple path and transport options across multiple time periods. The evaluation techniques are based on the evaluation metrics determined by the process and combinations thereof. For n evaluation metrics, the process uses 2ⁿ−1 evaluation techniques. Thus, for the present embodiment that includes four evaluation metrics A, B, C, and D, the process uses fifteen evaluation techniques, where each evaluation technique includes a respective one of the following evaluation functions:
f1: Transportation cost, A
f2: Number of vehicles used, D
f3: Degree of demand satisfaction, B
f4: Extent of supply consumption, C
f5: Extent of supply consumption/Number of vehicles used/Transportation cost, C/D/A
f6: Extent of supply consumption/Transportation cost, C/A
f7: Extent of supply consumption/Number of vehicles used, C/D
f8: Number of vehicles used/Transportation cost, D/A
f9: Degree of demand satisfaction/Transportation cost, B/A
f10: Degree of demand satisfaction/Extent of supply consumption, B/C
f11: Degree of demand satisfaction/Number of vehicles used, B/D
f12: Extent of supply consumption/Degree of demand satisfaction/Transportation cost, C/B/A
f13: Number of vehicles used/Degree of demand satisfaction/Transportation cost, D/B/A
f14: Extent of supply consumption/Degree of demand satisfaction/Number of vehicles used, C/B/D
f15: Number of vehicles used/Extent of supply consumption/Degree of demand satisfaction/Transportation cost, D/C/B/A

In the illustrated embodiment, the process also builds demand and supply constraints for the current distribution and transport problem. The process will then check candidate delivery routes for compliance with the constraints. Examples of constraints for an embodiment are as follows:
a) Vehicle transport load, i.e., a transport weight of a vehicle k cannot exceed the maximize load rating for that vehicle
b) Factory demand satisfaction, the supplied dairy products must meet the demand of the dairy factory on a per-category basis
c) Limited Source supply, the load amount at a source node cannot exceed the amount of food product available on a per-category basis

Once the constraints are established, the process performs the hybrid A-Star steps. In some embodiments, the hybrid A-Star steps include the following:
i. For each candidate path, compute 2ⁿ−1 evaluation values using respective evaluation techniques based on n evaluation metrics
ii. Check if the searching efficiency of the candidate paths is less than a predefined threshold and if the candidate paths meet the constraints
iii. If the searching efficiency exceeds the predefined threshold and/or conflicts are detected, the number of queue entries and the search space is limited and conflicts are resolved
iv. If the searching efficiency does not exceed the predefined threshold, the process continues to the next step
v. Select the path with most homogeneity of variance as the best path. Otherwise, select the path randomly or allow selection of a path by a user

In the above algorithm, the threshold is a threshold of the search efficiency that must meet and enforce production requirements. The A-Star algorithm is a very effective direct search method for solving for the shortest path in a static road network, and it is also an effective algorithm for solving many search problems. Its implementation is based on the simplest Breadth First Search, and its search efficiency is greatly improved the disclosed use of the multiple evaluation techniques. Also, queue entry and exit can be parameterized in some embodiments to ensure that the queue will still be available for very large numbers of queues.

In the illustrated embodiment, the process stores data in a database that is stored on a computer readable storage medium and is used to store persistent data. For example, the delivery routes may be stored as delivery routes data in the database. The selected paths output by the hybrid A-Star algorithm represent respective delivery routes stored in the database. The delivery route data may include information such as the source node, a destination node, and any nodes between the source and destination nodes, including characteristic data associated with the nodes. The delivery route data may also include data identifying a transport vehicle to be used, load amounts of food items on a per-category basis, start time/date, distances along the route, and any other information that may be helpful for communicating the requirements and other information about the route to the driver or other interested parties.

The process may use the route information to set up route plans. In some embodiments, the route plans may include delivery schedules for respective drivers. The route plans may include any of the information stored in the database associated with delivery route information, such as identifying a transport vehicle to be used, load amounts of food items on a per-category basis, start time/date, distances along the route. and any other information that may be helpful. The process may then output the route plans as a transport loading and routing report.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. The steps described by the various illustrative embodiments can be adapted for providing explanations for decisions made by a machine-learning classifier model, for example.

Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, contrastive explanations, computer readable storage medium, high-level features, training data, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefore, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

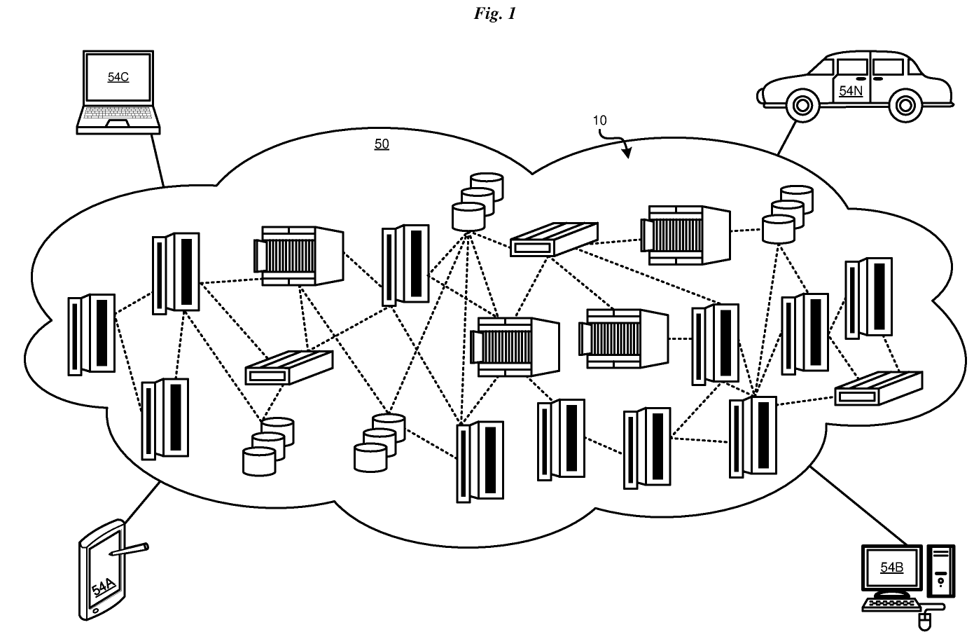

With reference to FIG. 1, this figure illustrates cloud computing environment 50. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

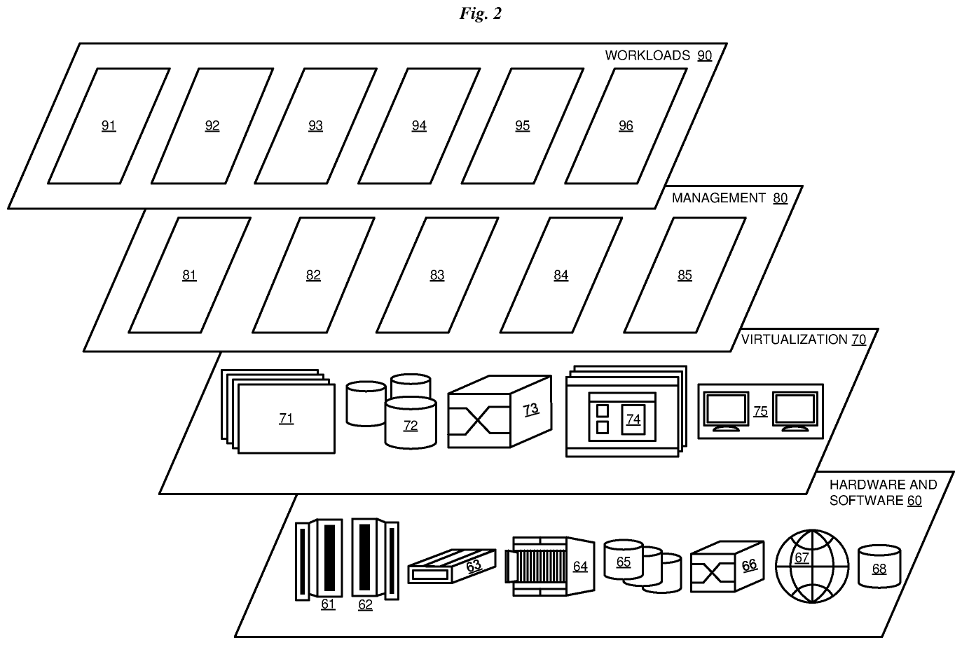

With reference to FIG. 2, this figure depicts a set of functional abstraction layers provided by cloud computing environment 50 (FIG. 1). It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and in the context of the illustrated embodiments of the present disclosure, various workloads and functions 96 for distribution optimization processing. In addition, workloads and functions 96 for distribution optimization processing may include such operations as data analysis and machine learning (e.g., artificial intelligence, natural language processing, etc.), as described herein. In some embodiments, the workloads and functions 96 for distribution optimization processing also works in conjunction with other portions of the various abstractions layers, such as those in hardware and software 60, virtualization 70, management 80, and other workloads 90 (such as data analytics processing 94, for example) to accomplish the various purposes of the disclosed embodiments.

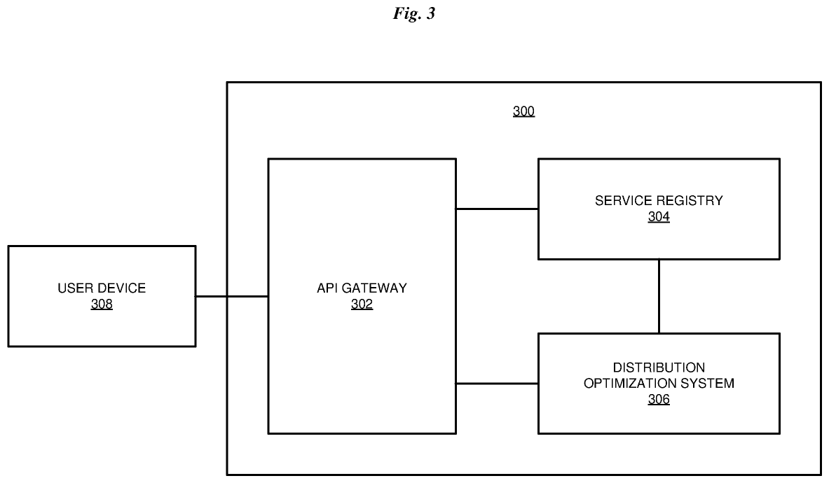

With reference to FIG. 3, this figure depicts a block diagram of an example service infrastructure 300 that includes a distribution optimization system 306 in accordance with an illustrative embodiment. In some embodiments, the distribution optimization system 306 is deployed in workloads layer 90 of FIG. 2. By way of example, in some embodiments, distribution optimization system 306 is implemented as a cloud-based system that may be shared by multiple users, for example across a department, organization, or enterprise.

In the illustrated embodiment, the service infrastructure 300 provides services and service instances to a user device 308. User device 308 communicates with service infrastructure 300 via an API gateway 302. In various embodiments, service infrastructure 300 and its associated distribution optimization system 306 serve multiple users and multiple tenants. A tenant is a group of users (e.g., a company) who share a common access with specific privileges to the software instance. Service infrastructure 300 ensures that tenant specific data is isolated from other tenants.

In some embodiments, user device 308 connects with API gateway 302 via any suitable network or combination of networks such as the Internet, etc. and use any suitable communication protocols such as Wi-Fi, Bluetooth, etc. Service infrastructure 300 may be built on the basis of cloud computing. API gateway 302 provides access to client applications like distribution optimization system 306. API gateway 302 receives service requests issued by client applications, and creates service lookup requests based on service requests. As a non-limiting example, in an embodiment, the user device 308 includes software, such as a web browser or route planning software that communicates with the distribution optimization system 306, including allowing a user to input information for the distribution optimization system 306 or view information output by the distribution optimization system 306.

In the illustrated embodiment, service infrastructure 300 includes a service registry 304. In some embodiments, service registry 304 looks up service instances of distribution optimization system 306 in response to a service lookup request such as one from API gateway 302 in response to a service request from user device 308. For example, in some embodiments, the service registry 304 looks up service instances of distribution optimization system 306 in response to requests from the user device 308 related to route planning or distribution optimization.

In some embodiments, the service infrastructure 300 includes one or more instances of the distribution optimization system 306. In some such embodiments, each of the multiple instances of the distribution optimization system 306 run independently on multiple computing systems. In some such embodiments, distribution optimization system 306, as well as other service instances of distribution optimization system 306, are registered in service registry 304.

In some embodiments, service registry 304 maintains information about the status or health of each service instance including performance information associated each of the service instances. For example, such performance information may include several types of performance characteristics of a given service instance (e.g., cache metrics, etc.). In some embodiments, the extended service registry 304 ranks service instances based on their respective performance characteristics, and selects top-ranking service instances for classification requests. In some such embodiments, in the event that a service instance becomes unresponsive or, unhealthy, the service registry will no longer provide its address or information about this service instance to other services.

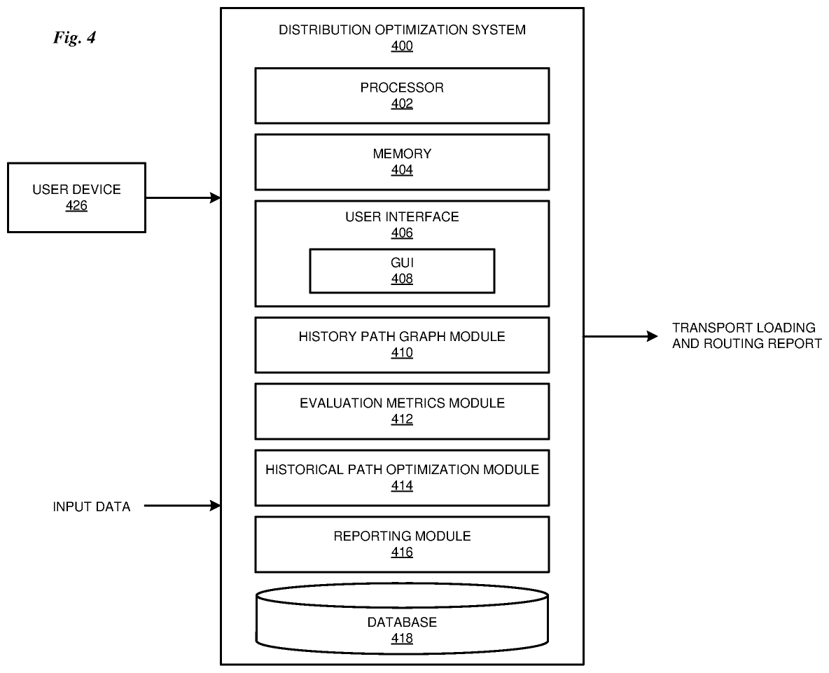

With reference to FIG. 4, this figure depicts a block diagram of an example distribution optimization system 400 in accordance with an illustrative embodiment. In a particular embodiment, the distribution optimization system 400 is an example of the workloads and functions 96 for classifier processing of FIG. 1.

In some embodiments, the distribution optimization system 400 includes a processor 402, memory 404, a user interface 406 that includes a graphical user interface (GUI) 408, a history path graph module 410, an evaluation metrics module 412, a historical path optimization module 414, a reporting module 416, and a database 418. In alternative embodiments, the distribution optimization system 400 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the processing unit (“processor”) 402 performs various computational and data processing tasks, as well as other functionality. The processing unit 402 is in communication with memory 404. In some embodiments, the memory 404 comprises one or more computer readable storage media with program instructions collectively stored on the one or more computer readable storage media, with the program instructions being executable by one or more processors 402 to cause the one or more processors 402 to perform operations described herein.

In the illustrated embodiment, the user interface 406 provides a point of human interaction with the distribution optimization system 400. For example, in the illustrated embodiment, the user interface 406 communicates with a user device 426 via a network, such as the Internet or a private network. The user device 426 may be any type of user computing device, for example the personal digital assistant (PDA) or cellular telephone 54A, desktop computer 54B, laptop computer 54C, and/or automobile computer system 54N shown in FIG. 1, and may include such things as a display, touch screen, keyboard, processor, memory, network interface, and other known components of such computing devices.

In the illustrated embodiment, the history path graph module 410 is configured to parse geographical data into a path graph by storing a plurality of nodes representative of respective locations and by storing a plurality of edges representative of respective vehicle routes between pairs of locations. In some embodiments, the history path graph module 410 fetches or receives characteristic data for routes and locations represented by the nodes and edges from one or more sources, for example from user input, a local and/or remote database, or public data sources such as public Application Programming Interface (API) that provides weather or traffic information. In some embodiments, once the data is collected, the history path graph module 410 translates the data to a graph format.

In some embodiments, the history path graph module 410 assembles the graph formatted data as a data structure assembled in chronological order with two fields—nodes and edges—that are arrays of node objects and edge objects. In some embodiments, the edges include data fields that identify a pair of nodes that the edge connects. In some embodiments, there are two types of nodes—source nodes and destination nodes—that may be distinguishable in various ways, such as data attributes or distinct classes.

In some embodiments, the history path graph module 410 associates characteristic data with corresponding nodes and edges. In some embodiments, the nodes and edges have a data property that is used to store the associated characteristic data about the node/edge. In some embodiments, the characteristic data includes data that is relevant to generating and/or optimizing delivery routes. It will be appreciated that much of the characteristic data may be implementation-specific. However, as an example, in some embodiments, the characteristic data includes supplier characteristic data, processor characteristic data, and transport characteristic data.

In some embodiments, when the history path graph module 410 identifies a node that corresponds with some characteristic data, the history path graph module 410 associates the characteristic data with that node, and then identifies the node as a source node if the characteristic data is supplier characteristic data or as a destination node if the characteristic data is processor characteristic data. In some embodiments, the source nodes represent dairy farms and the characteristic data in the data property of the source nodes may include supplier characteristic data such as product categories (e.g., categories of perishable food) produced by the dairy farm and respective production levels, as well as location, hours of operation, point of contact information, and so on. In some embodiments, transport vehicles are provided by the dairy farms, and the data property includes supplier characteristic data about available vehicles, such as the number of vehicles, the respective load capacities, cost of operation (e.g., dollars per mile or per hour), etc.

In some such embodiments, the destination nodes represent dairy factories and the characteristic data in the data property of the destination nodes may include processor characteristic data such as product categories (e.g., categories of perishable food products) processed by the dairy factory, intake limits for the respective product categories, as well as location, hours of operation, point of contact information, and so on. In some such embodiments, the edges represent vehicle routes (i.e., roads, highways, etc.) and the characteristic data in the data property of the edges may include transport characteristic data such as travel distance, height and/or weight restrictions, tolls, steep grades, road construction or road closures, etc.

In the illustrated embodiment, the evaluation metrics module 412 is configured to determine evaluation metrics that provide bases for evaluation techniques used to select optimal delivery routes. It will be appreciated that the number and types of metrics may be highly implementation specific, for example depending on the goals of the implementation. As an example, in some embodiments, the following four metrics are used:
A. Minimize transport cost: transport cost=Σₖ₌₁^{K}Xᵢⱼₖ*Dᵢⱼ*Uᵢⱼ
B. Maximize factory demand satisfaction: Supply/Demand on a per-product-category basis
C. Maximize the extent of farm production utilization: Transport/Supply on a per-product-category basis
D. Minimize the number of vehicles used: Σₖ₌₁^{K} Vehicle on a per-category basis
   The above four metrics are sometimes referred to herein as metrics A, B, C, and D as designated above. In metrics A, B, C, and D, i represents a dairy farm, j represents a dairy factory, k represents a vehicle of K total vehicles, Dᵢⱼ represents a distance from dairy farm i to dairy factory j, Uᵢⱼ represents a unit transportation cost from dairy farm i to dairy factory j, and Xᵢⱼₖ represents tonnage transported from dairy farm i to dairy factory j using vehicle k. While four metrics are used in this embodiment, alternative embodiments may use more or fewer metrics.

In the illustrated embodiment, the historical path optimization module 414 performs a graph traversal and path search algorithm on the path graph generated by the history path graph module 410 to generate optimal delivery routes. In some embodiments, the historical path optimization module 414 uses a new hybrid A-Star algorithm introduced herein.

The hybrid A-Star algorithm disclosed herein is a variation of the known A-Star algorithm, which is a best-first graph search algorithm that finds the least-cost path from a given initial node to one goal node (out of one or more possible goals). All possible paths from a start point to a destination point may be sequentially examined in order of increasing cost. Thus, A-star uses a distance-plus-cost heuristic function (usually denoted f(x)) to determine the order in which the search visits nodes in the tree. The distance-plus-cost heuristic may be a sum of two functions: the path-cost function, which is the cost from the starting node to the current node (usually denoted g(x)); and an admissible “heuristic estimate” of the distance to the goal (usually denoted h(x)).

The hybrid A-Star algorithm disclosed herein uses a heuristic estimate based on an evaluation cost that is determined using a plurality of evaluation techniques as indicated by expression (1) discussed above and shown again below.

$$For i in {2}^{n} - 1 : {h}_{i}^{n} = {\sum }_{s = n}^{target} {w}_{s} {f}_{i} \qquad ( 1 )$$

In expression (1), hᵢⁿ is the evaluation function ƒᵢ that contributes to the estimated cost, wₛ is a constant coefficient, and ƒᵢ is the corresponding evaluation function i. Note that each valid hᵢⁿ needs to meet production requirements, such as the constraints discussed below.

The hybrid A-Star algorithm starts at a source node and uses a plurality of evaluation techniques to evaluate multiple path and transport options across multiple time periods. The evaluation techniques are based on the evaluation metrics determined by the evaluation metrics module 412 and combinations thereof. For n evaluation metrics, the historical path optimization module 414 uses 2ⁿ−1 evaluation techniques. Thus, for the present embodiment that includes four evaluation metrics A, B, C, and D, the historical path optimization module 414 uses fifteen evaluation techniques, where each evaluation technique includes a respective one of the following evaluation functions:
f1: Transportation cost, A
f2: Number of vehicles used, D
f3: Degree of demand satisfaction, B
f4: Extent of supply consumption, C
f5: Extent of supply consumption/Number of vehicles used/Transportation cost, C/D/A
f6: Extent of supply consumption/Transportation cost, C/A
f7: Extent of supply consumption/Number of vehicles used, C/D
f8: Number of vehicles used/Transportation cost, D/A
f9: Degree of demand satisfaction/Transportation cost, B/A
f10: Degree of demand satisfaction/Extent of supply consumption, B/C
f11: Degree of demand satisfaction/Number of vehicles used, B/D
f12: Extent of supply consumption/Degree of demand satisfaction/Transportation cost, C/B/A
f13: Number of vehicles used/Degree of demand satisfaction/Transportation cost, D/B/A
f14: Extent of supply consumption/Degree of demand satisfaction/Number of vehicles used, C/B/D
f15: Number of vehicles used/Extent of supply consumption/Degree of demand satisfaction/Transportation cost, D/C/B/A

In the illustrated embodiment, the historical path optimization module 414 also builds demand and supply constraints for the current distribution and transport problem. The historical path optimization module 414 will then check candidate delivery routes for compliance with the constraints. Examples of constraints for an embodiment are as follows:
a) Vehicle transport load, i.e., a transport weight of a vehicle k cannot exceed the maximize load rating for that vehicle
b) Factory demand satisfaction, the supplied dairy products must meet the demand of the dairy factory on a per-category basis
c) Limited Source supply, the load amount at a source node cannot exceed the amount of food product available on a per-category basis

Once the constraints are established, the historical path optimization module 414 performs the hybrid A-Star steps. In some embodiments, the hybrid A-Star steps include the following:
i. For each candidate path, compute 2ⁿ−1 evaluation values using respective evaluation techniques based on n evaluation metrics
ii. Check if the searching efficiency of the candidate paths is less than a predefined threshold and if the candidate paths meet the constraints
iii. If the searching efficiency exceeds the predefined threshold and/or conflicts are detected, the number of queue entries and the search space is limited and conflicts are resolved
iv. If the searching efficiency does not exceed the predefined threshold, the process continues to the next step
v. Select the path with most homogeneity of variance as the best path. Otherwise, select the path randomly or allow selection of a path by a user

In the above algorithm, the threshold is a threshold of the search efficiency that must meet and enforce production requirements. The A-Star algorithm is a very effective direct search method for solving for the shortest path in a static road network, and it is also an effective algorithm for solving many search problems. Its implementation is based on the simplest Breadth First Search, and its search efficiency is greatly improved the disclosed use of the multiple evaluation techniques. Also, queue entry and exit can be parameterized in some embodiments to ensure that the queue will still be available for very large numbers of queues.

In the illustrated embodiment, the database 424 is stored on a computer readable storage medium and is used to store persistent data for the distribution optimization system 400. For example, the delivery routes may be stored as delivery routes data in the database 418. The selected paths output by the hybrid A-Star algorithm represent respective delivery routes stored in the database 424. The delivery route data may include information such as the source node, a destination node, and any nodes between the source and destination nodes, including characteristic data associated with the nodes. The delivery route data may also include data identifying a transport vehicle to be used, load amounts of food items on a per-category basis, start time/date, distances along the route, and any other information that may be helpful for communicating the requirements and other information about the route to the driver or other interested parties.

The reporting module 416 may use the route information stored in the database 418 to set up route plans. In some embodiments, the route plans may include delivery schedules for respective drivers. The route plans may include any of the information stored in the database 418 associated with delivery route information, such as identifying a transport vehicle to be used, load amounts of food items on a per-category basis, start time/date, distances along the route. and any other information that may be helpful. The distribution optimization system 400 may then output the route plans as a transport loading and routing report.

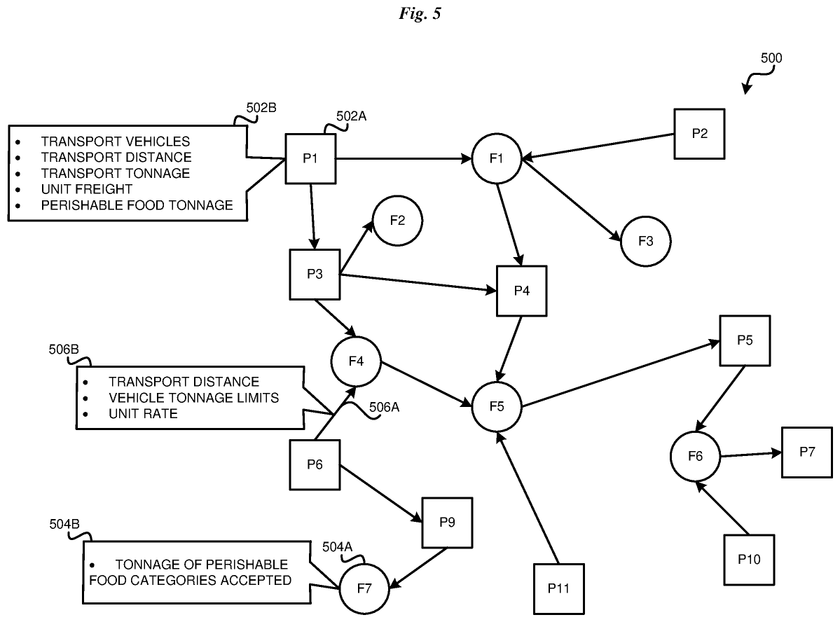

With reference to FIG. 5, this figure depicts an example of a path graph 500 according to an embodiment. In some embodiments, the path graph 500 is an example of a graph assembled by the history path graph module 410 of FIG. 4.

The path graph 500 is representative of an example geographical network comprising food production nodes 502A, which include square nodes designated P1-P11, food factory nodes 504A, which include circular nodes designated F1-F7, and edges 506A connecting pairs of nodes 504A and/or 502A. Edges 506A represent travel routes between the connected pair of nodes, which may include one or more roads, highways, etc. While edges 506A are shown as directional to indicate the general movement of food products from producers to factories, the actual roads of the travel routes are not necessarily one-way, but may be bi-directional.

In some embodiments, the path graph 500 is a visual representation of graph formatted data having two fields—nodes and edges—that are arrays of node objects and edge objects. In some embodiments, the edges 506A include data fields that identify a pair of nodes that the edge connects. In the illustrated embodiment, there are two types of nodes—production nodes 502A, which are examples of source nodes, and factory nodes 504A, which are examples of destination nodes—that may be distinguishable in various ways, such as data attributes or distinct classes.

In some embodiments, the path graph 500 associates characteristic data with corresponding nodes and edges. In some embodiments, the nodes and edges have a data property that is used to store the associated characteristic data about the node/edge. In some embodiments, the characteristic data includes data that is relevant to generating and/or optimizing delivery routes. It will be appreciated that much of the characteristic data may be implementation-specific. However, as an example, in some embodiments, the characteristic data includes supplier characteristic data 502B associated with production nodes 502A, processor characteristic data 504B associated with factory nodes 504A, and transport characteristic data 506B associated with edges 506A.

In some embodiments, when the history path graph module 410 (shown in FIG. 4) identifies a node that corresponds with some characteristic data, the history path graph module 410 associates the characteristic data with that node, and then identifies the node as a production node if the characteristic data is supplier characteristic data or as a factory node if the characteristic data is processor characteristic data. In some embodiments, the production nodes 502A represent dairy farms and the characteristic data in the data property of the production nodes 502A may include supplier characteristic data such as product categories (e.g., categories of perishable food) produced by the dairy farm and respective production levels (e.g., perishable food tonnage), as well as location, hours of operation, point of contact information, and so on. In some embodiments, transport vehicles are provided by the dairy farms, and the data property includes supplier characteristic data about available vehicles, such as the type and number of vehicles, the respective load capacities (e.g., transport tonnage), transport distances, cost of operation (e.g., unit freight, dollars per mile or per hour), etc.

In some such embodiments, the factory nodes 504A represent dairy factories and the characteristic data in the data property of the factory nodes 504A may include processor characteristic data such as product categories (e.g., categories of perishable food products) processed by the dairy factory, intake limits for the respective product categories (e.g., tonnage of perishable food categories accepted), as well as location, hours of operation, point of contact information, and so on. In some such embodiments, the edges 506A represent vehicle routes (i.e., roads, highways, etc.) and the characteristic data in the data property of the edges may include transport characteristic data 506B such as travel or transport distance, height and/or weight restrictions (e.g., vehicle tonnage limits), unit rate, tolls, steep grades, road construction or road closures, etc.

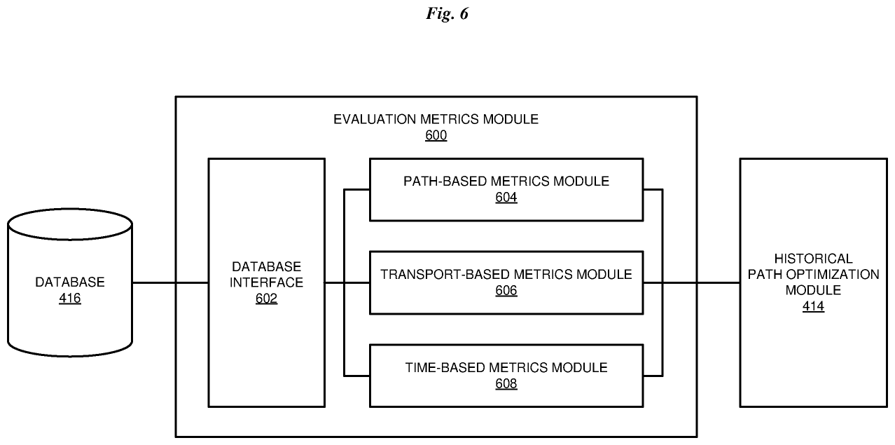

With reference to FIG. 6, this figure depicts a block diagram of an example evaluation metrics module 600 in accordance with an illustrative embodiment. In a particular embodiment, the evaluation metrics module 600 is an example of the evaluation metrics module 412 of FIG. 4.

In some embodiments, the evaluation metrics module 600 includes a database interface 602, a path-based metrics module 604, a transport-based metrics module 606, and a time-based metrics module 608. In alternative embodiments, the evaluation metrics module 600 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the evaluation metrics module 600 is configured to determine evaluation metrics that provide bases for evaluation techniques used to select optimal delivery routes. It will be appreciated that the number and types of metrics may be highly implementation specific, for example depending on the goals of the implementation. As an example, in some embodiments, the following four metrics are used:
A. Minimize transport cost: transport cost=Σₖ₌₁^{K}Xᵢⱼₖ*Dᵢⱼ*Uᵢⱼ
B. Maximize factory demand satisfaction: Supply/Demand on a per-product-category basis
C. Maximize the extent of farm production utilization: Transport/Supply on a per-product-category basis
D. Minimize the number of vehicles used: Σₖ₌₁^{K} Vehicle on a per-category basis
   The above four metrics are sometimes referred to herein as metrics A, B, C, and D as designated above. In metrics A, B, C, and D, i represents a dairy farm, j represents a dairy factory, k represents a vehicle of K total vehicles, Dᵢⱼ represents a distance from dairy farm i to dairy factory j, Uᵢⱼ represents a unit transportation cost from dairy farm i to dairy factory j, and Xᵢⱼₖ represents tonnage transported from dairy farm i to dairy factory j using vehicle k. While four metrics are used in this embodiment, alternative embodiments may use more or fewer metrics.

In some embodiments, the database interface 602 communicates with database 418 to fetch previously-used metrics, for example in response to a user request. In some embodiments, the database interface 602 detects categorization data associated with the fetched metrics and relays each metric to an appropriate one of the path-based metrics module 604, transport-based metrics module 606, and time-based metrics module 608. While path, transport, and time categories are shown, it will be appreciated that other categories may be used, including more or less than three categories. The categorized modules provide an organizational structure for presenting the previously-used metrics to a user. In some embodiments, a user may then select from previously-used metrics for optimizing a new delivery or routing schedule, and/or may introduce new metrics in place of, or in addition to, the previously-used metrics. The user-selected or created metrics are then provided to the historical path optimization module 414.

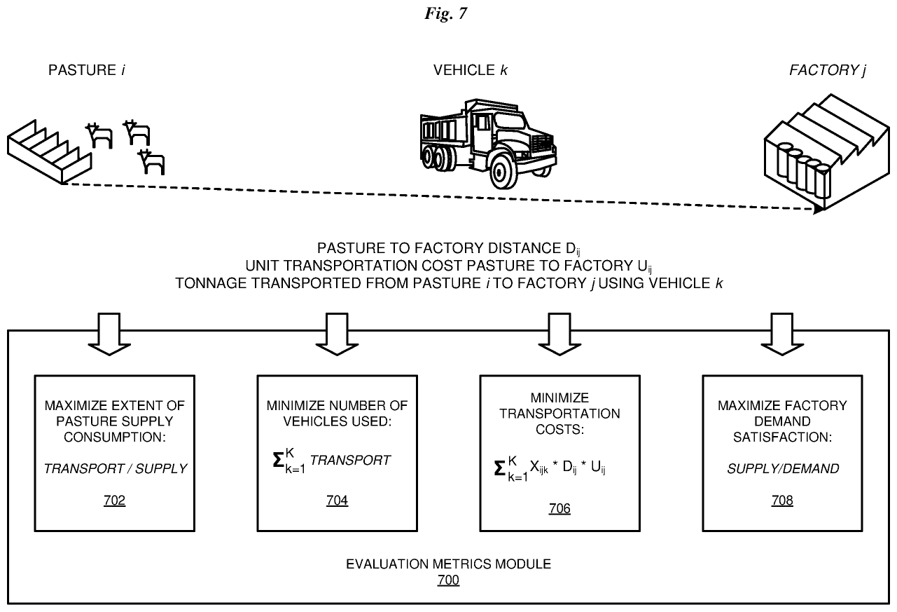

With reference to FIG. 7, this figure depicts a block diagram of an example evaluation metrics module 700 in accordance with an illustrative embodiment. In a particular embodiment, the evaluation metrics module 700 is an example of the evaluation metrics module 412 of FIG. 4.

In some embodiments, the evaluation metrics module 700 allows a user to select or create metrics related to various aspects of a route plan that the user seeks to optimize. In the illustrated embodiment, the user creates four metrics:
A. Minimize transport cost: transport cost=Σₖ₌₁^{K}Xᵢⱼₖ*Dᵢⱼ*Uᵢⱼ (702)
B. Maximize factory demand satisfaction: Supply/Demand on a per-product-category basis (704)
Maximize the extent of farm production utilization: Transport/Supply on a per-product-category basis (706)
D. Minimize the number of vehicles used: Σₖ₌₁^{K} Vehicle on a per-category basis (708)
   The above four metrics are also referred to herein as metrics A, B, C, and D as designated above. In metrics A, B, C, and D, i represents a pasture or dairy farm, j represents a dairy factory, k represents a vehicle of K total vehicles, Dᵢⱼ represents a distance from dairy farm i to dairy factory j, Uᵢⱼ represents a unit transportation cost from dairy farm i to dairy factory j, and Xᵢⱼₖ represents tonnage transported from dairy farm i to dairy factory j using vehicle k. While four metrics are used in this embodiment, alternative embodiments may use more or fewer metrics.

In some embodiments, a user may then select from previously-used metrics for optimizing a new delivery or routing schedule, and/or may introduce new metrics in place of, or in addition to, the previously-used metrics. The user-selected or created metrics are then provided to the historical path optimization module 414 (shown in FIG. 4).

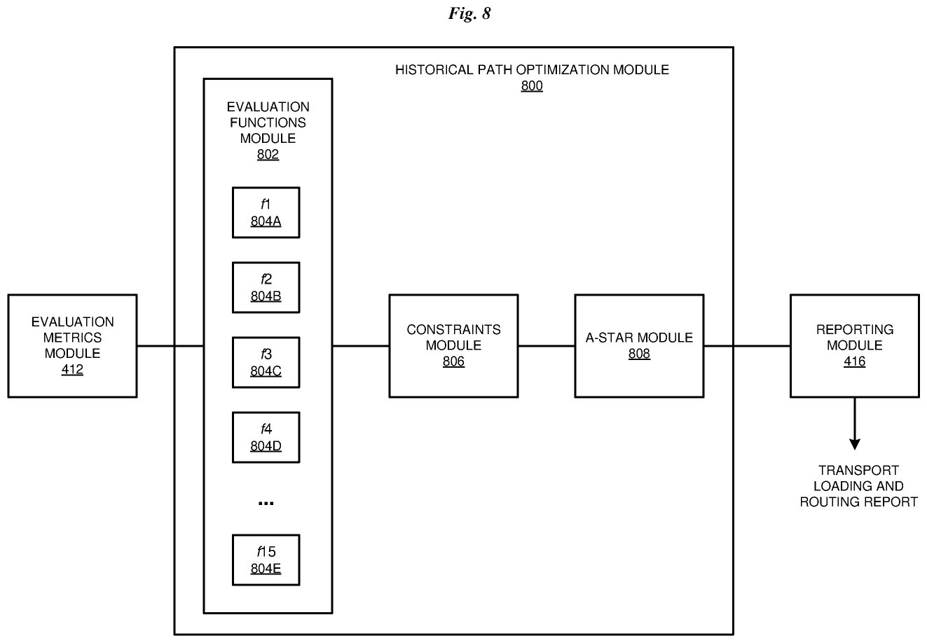

With reference to FIG. 8, this figure depicts a block diagram of an example historical path optimization module 800 in accordance with an illustrative embodiment. In a particular embodiment, the historical path optimization module 800 is an example of the historical path optimization module 414 of FIG. 4.

In some embodiments, the historical path optimization module 800 includes an evaluation functions module 802 having a plurality of evaluation function elements 804A-804E, a constraints module 806, and an A-Star module 808. In alternative embodiments, the historical path optimization module 800 can include some or all of the functionality described herein but grouped differently into one or more modules. In some embodiments, the functionality described herein is distributed among a plurality of systems, which can include combinations of software and/or hardware-based systems, for example Application-Specific Integrated Circuits (ASICs), computer programs, or smart phone applications.

In the illustrated embodiment, the historical path optimization module 800 performs a graph traversal and path search algorithm on the path graph generated by the history path graph module 410 (shown in FIG. 4) to generate optimal delivery routes. In some embodiments, the historical path optimization module 800 uses a new hybrid A-Star algorithm introduced herein.

The hybrid A-Star algorithm disclosed herein is a variation of the known A-Star algorithm, which is a best-first graph search algorithm that finds the least-cost path from a given initial node to one goal node (out of one or more possible goals). All possible paths from a start point to a destination point may be sequentially examined in order of increasing cost. Thus, A-star uses a distance-plus-cost heuristic function (usually denoted f(x)) to determine the order in which the search visits nodes in the tree. The distance-plus-cost heuristic may be a sum of two functions: the path-cost function, which is the cost from the starting node to the current node (usually denoted g(x)); and an admissible “heuristic estimate” of the distance to the goal (usually denoted h(x)).

The historical path optimization module 800 is configured for performing a hybrid A-Star algorithm using an evaluation functions module 802. The evaluation functions module 802 uses a heuristic estimate based on an evaluation cost that is determined using a plurality of evaluation techniques that are each associated with a respective one of the evaluation functions ƒ1-ƒ15 of evaluation function elements 804A-804E. The evaluation techniques are based on the evaluation metrics (and combinations thereof) that the evaluation functions module 802 receives from the evaluation metrics module 412. For any integer n evaluation metrics, there are 2ⁿ−1 possible combinations of one or more of the n metrics, so the historical path optimization module 800 uses 2ⁿ−1 evaluation techniques. Thus, for the present embodiment that includes the four evaluation metrics A, B, C, and D identified above, the historical path optimization module 800 uses fifteen evaluation techniques: A, B, C, D, AB, AC, AD, BC, BD, CD, ABC, ABD, ACD, BCD, and ABCD.

In the illustrated embodiment, the constraints module 806 builds demand and supply constraints for the current distribution and transport problem. The constraints module 806 will then check candidate delivery routes for compliance with the constraints. Examples of constraints for an embodiment are as follows:
a) Vehicle transport load, i.e., a transport weight of a vehicle k cannot exceed the maximize load rating for that vehicle
b) Factory demand satisfaction, the supplied dairy products must meet the demand of the dairy factory on a per-category basis
c) Limited Source supply, the load amount at a source node cannot exceed the amount of food product available on a per-category basis

Once the constraints are established, the A-Star module 808 performs the hybrid A-Star steps. In some embodiments, the hybrid A-Star steps include the following:
i. For each candidate path, compute 2ⁿ−1 evaluation values using respective evaluation techniques based on n evaluation metrics
ii. Check if the searching efficiency of the candidate paths is less than a predefined threshold and if the candidate paths meet the constraints
iii. If the searching efficiency exceeds the predefined threshold and/or conflicts are detected, the number of queue entries and the search space is limited and conflicts are resolved
iv. If the searching efficiency does not exceed the predefined threshold, the process continues to the next step
v. Select the path with most homogeneity of variance as the best path. Otherwise, select the path randomly or allow selection of a path by a user

In the above algorithm, the threshold is a threshold of the search efficiency that must meet and enforce production requirements. The A-Star algorithm is a very effective direct search method for solving for the shortest path in a static road network, and it is also an effective algorithm for solving many search problems. Its implementation is based on the simplest Breadth First Search, and its search efficiency is greatly improved the disclosed use of the multiple evaluation techniques. Also, queue entry and exit can be parameterized in some embodiments to ensure that the queue will still be available for very large numbers of queues.

In the illustrated embodiment, the A-Star module 808 outputs optimal delivery routes may be stored as delivery routes data, for example in the database 418 (shown in FIG. 4). The selected paths output by the A-Star module 808 represent respective delivery routes stored in the database 418. The delivery route data may include information such as the source node, a destination node, and any nodes between the source and destination nodes, including characteristic data associated with the nodes. The delivery route data may also include data identifying a transport vehicle to be used, load amounts of food items on a per-category basis, start time/date, distances along the route, and any other information that may be helpful for communicating the requirements and other information about the route to the driver or other interested parties. This data is output to the reporting module 416.

The reporting module 416 may use the route information stored in the database 418 to set up route plans. In some embodiments, the route plans may include delivery schedules for respective drivers. The route plans may include any of the information stored in the database 418 associated with delivery route information, such as identifying a transport vehicle to be used, load amounts of food items on a per-category basis, start time/date, distances along the route, and any other information that may be helpful. The reporting module 416 may then output the route plans as a transport loading and routing report.

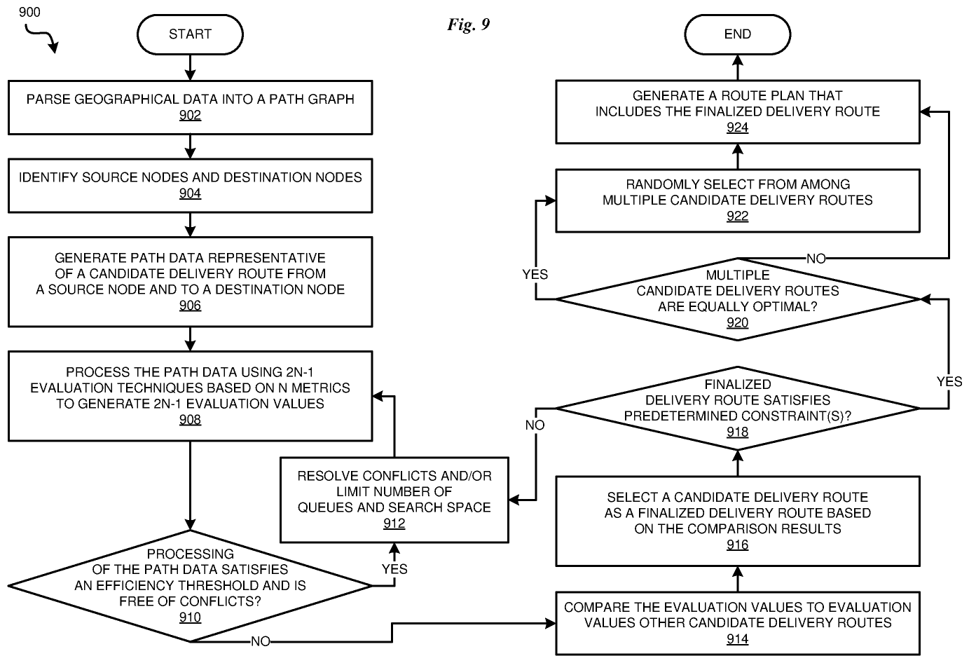

With reference to FIG. 9, this figure depicts a flowchart of an example process 900 for cognitive route planning using metric-based combinatorial evaluation techniques in accordance with an illustrative embodiment. In a particular embodiment, the distribution optimization system 400 carries out the process 900.

In an embodiment, at block 902, the process parses geographical data into a path graph. In some embodiments, the process parses the data by storing a plurality of nodes representative of respective physical locations and storing a plurality of edges representative of respective vehicle routes between pairs of locations represented by nodes.

Next, at block 904, the process identifies source nodes and destination nodes from among the plurality of nodes. In some embodiments, the process identifies source nodes and destination nodes based on characteristic data associated with the nodes. In some embodiments, the source nodes are a first subset of the plurality of nodes and the destination nodes are a second, mutually exclusive, subset of the plurality of nodes.

Next, at block 906, the process generates path data representative of a candidate delivery route from a source node and to a destination node. In some embodiments, the path data comprises data for an edge connected between the first source node and the first destination node. In some embodiments, the first candidate delivery route includes loading a perishable food item at the source node, traveling along the vehicle route represented by the first edge, and delivering the perishable food item at the destination node;

Next, at block 908, the process processes the path data using 2ⁿ−1 evaluation techniques based on n metrics to generate 2ⁿ−1 evaluation values. In some embodiments, the plurality of evaluation techniques comprises a first evaluation technique based on a first optimization metric, a second evaluation techniques based on a second optimization metric, and a third evaluation technique based on a combination of the first and second evaluation techniques.

Next, at block 910, the process determines if the processing of the path data satisfies an efficiency threshold and is free of conflicts. If not, the process proceeds to block 912, where the process resolves conflicts and/or limits the number of queues and search space, and then returns to block 908. Otherwise, the process continues to block 914, where the process compares the evaluation values to evaluation values of other candidate delivery routes.

Next, at block 916, the process selects a candidate delivery route as a finalized delivery route based on the comparison results. Next, at block 918, the process verifies that the finalized delivery route satisfies predetermined constraint(s). If not, the process proceeds to block 912, where the process resolves conflicts and/or limit number of queues and search space and then returns to block 908. Otherwise, the process continues to block 920, where the process determines if multiple candidate delivery routes are equally optimal. If so, the process proceeds to block 922, where the process randomly selects from among multiple candidate delivery routes, and then proceeds to block 924. Otherwise, the process skips block 922 and continues to block 924. At block 924, the process generates a route plan that includes the finalized delivery route.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer implemented method comprising:
parsing geographical data into a path graph by storing a plurality of nodes representative of respective locations and by storing a plurality of edges representative of respective vehicle routes between pairs of locations;
identifying first and second subsets of the plurality of nodes using characteristic data associated with the nodes, wherein the first subset of the plurality of nodes are identified as source nodes that produce perishable food items and the second subset of the plurality of nodes are identified as destination nodes that process perishable food items;
generating path data representative of a first path beginning at a first source node and ending at a first destination node, wherein the first path comprises a first edge connected between the first source node and the first destination node, and wherein the first path is a first candidate delivery route that includes loading a perishable food item at the first source node, traveling along the vehicle route represented by the first edge, and delivering the perishable food item at the first destination node;
processing the path data using a plurality of evaluation techniques that result in a first set of evaluation values, wherein the plurality of evaluation techniques comprises a first evaluation technique based on a first optimization metric, a second evaluation techniques based on a second optimization metric, and a third evaluation technique based on a combination of the first and second evaluation techniques;
comparing the first set of evaluation values to a second set of evaluation values of a second path associated with a second candidate delivery route that begins at the first source node;
selecting the first path as a first finalized delivery route based on a result of the comparing of the first set of evaluation values to the second set of evaluation values; and
generating a route plan that includes a plurality of finalized delivery routes that provide for delivery of perishable food items from the source nodes to the destination nodes, the plurality of finalized delivery routes including the first finalized delivery route.

2. The method of claim 1, wherein the parsing further comprises associating the characteristic data with each of the plurality of nodes and with each of the plurality of edges, wherein the characteristic data comprises supplier characteristic data, processor characteristic data, and transport characteristic data.

3. The method of claim 2, wherein the identifying of the first and second subsets comprises identifying nodes associated with supplier characteristic data as source nodes and identifying nodes associated with processor characteristic data as destination nodes.

4. The method of claim 2, wherein the supplier characteristic data includes data representative of categories of perishable food products available at an associated source node.

5. The method of claim 2, wherein the processor characteristic data includes data representative of categories of perishable food products processed at an associated destination node.

6. The method of claim 2, further comprising:
associating transport characteristic data with each of the plurality of edges, wherein the transport characteristic data includes data representative of a travel distance of an associated edge.

7. The method of claim 1, wherein the first optimization metric includes minimizing a sum of vehicles used in the route plan.

8. The method of claim 7, wherein the second optimization metric includes maximizing an amount of perishable food items transported from the source nodes.

9. The method of claim 1, further comprising:
generating constraint data representative of a constraint for the route plan; and
determining that the first finalized delivery route satisfies the constraint.

10. The method of claim 9, wherein the first finalized delivery route identifies a vehicle for transporting an amount of perishable food items from the first source node,
wherein the constraint is a transport capacity limit of the vehicle, and
wherein the determining that the first finalized delivery route satisfies the constraint comprises determining that the amount of perishable food items does not exceed the transport capacity limit of the vehicle.

11. A computer program product, the computer program product comprising one or more computer readable storage media, and program instructions collectively stored on the one or more computer readable storage media, the program instructions executable by one or more processors to cause the one or more processors to perform operations comprising:
parsing geographical data into a path graph by storing a plurality of nodes representative of respective locations and by storing a plurality of edges representative of respective vehicle routes between pairs of locations;
identifying first and second subsets of the plurality of nodes using characteristic data associated with the nodes, wherein the first subset of the plurality of nodes are identified as source nodes that produce perishable food items and the second subset of the plurality of nodes are identified as destination nodes that process perishable food items;
generating path data representative of a first path beginning at a first source node and ending at a first destination node, wherein the first path comprises a first edge connected between the first source node and the first destination node, and wherein the first path is a first candidate delivery route that includes loading a perishable food item at the first source node, traveling along the vehicle route represented by the first edge, and delivering the perishable food item at the first destination node;
processing the path data using a plurality of evaluation techniques that result in a first set of evaluation values, wherein the plurality of evaluation techniques comprises a first evaluation technique based on a first optimization metric, a second evaluation techniques based on a second optimization metric, and a third evaluation technique based on a combination of the first and second evaluation techniques;
comparing the first set of evaluation values to a second set of evaluation values of a second path associated with a second candidate delivery route that begins at the first source node;
selecting the first path as a first finalized delivery route based on a result of the comparing of the first set of evaluation values to the second set of evaluation values; and
generating a route plan that includes a plurality of finalized delivery routes that provide for delivery of perishable food items from the source nodes to the destination nodes, the plurality of finalized delivery routes including the first finalized delivery route.

12. The computer program product of claim 11, wherein the stored program instructions are stored in a computer readable storage device in a data processing system, and wherein the stored program instructions are transferred over a network from a remote data processing system.

13. The computer program product of claim 11, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

14. The computer program product of claim 11, wherein the parsing further comprises associating the characteristic data with each of the plurality of nodes and with each of the plurality of edges, wherein the characteristic data comprises supplier characteristic data, processor characteristic data, and transport characteristic data.

15. The computer program product of claim 14, wherein the identifying of the first and second subsets comprises identifying nodes associated with supplier characteristic data as source nodes and identifying nodes associated with processor characteristic data as destination nodes.

16. The computer program product of claim 14, wherein the supplier characteristic data includes data representative of categories of perishable food products available at an associated source node.

17. The computer program product of claim 14, wherein the processor characteristic data includes data representative of categories of perishable food products processed at an associated destination node.

18. The computer program product of claim 14, wherein the operations further comprise:
associating transport characteristic data with each of the plurality of edges, wherein the transport characteristic data includes data representative of a travel distance of an associated edge.

19. A computer system comprising one or more processors and one or more computer readable storage media, and program instructions collectively stored on the one or more computer readable storage media, the program instructions executable by the one or more processors to cause the one or more processors to perform operations comprising:
parsing geographical data into a path graph by storing a plurality of nodes representative of respective locations and by storing a plurality of edges representative of respective vehicle routes between pairs of locations;
identifying first and second subsets of the plurality of nodes using characteristic data associated with the nodes, wherein the first subset of the plurality of nodes are identified as source nodes that produce perishable food items and the second subset of the plurality of nodes are identified as destination nodes that process perishable food items;
generating path data representative of a first path beginning at a first source node and ending at a first destination node, wherein the first path comprises a first edge connected between the first source node and the first destination node, and wherein the first path is a first candidate delivery route that includes loading a perishable food item at the first source node, traveling along the vehicle route represented by the first edge, and delivering the perishable food item at the first destination node;
processing the path data using a plurality of evaluation techniques that result in a first set of evaluation values, wherein the plurality of evaluation techniques comprises a first evaluation technique based on a first optimization metric, a second evaluation techniques based on a second optimization metric, and a third evaluation technique based on a combination of the first and second evaluation techniques;
comparing the first set of evaluation values to a second set of evaluation values of a second path associated with a second candidate delivery route that begins at the first source node;
selecting the first path as a first finalized delivery route based on a result of the comparing of the first set of evaluation values to the second set of evaluation values; and
generating a route plan that includes a plurality of finalized delivery routes that provide for delivery of perishable food items from the source nodes to the destination nodes, the plurality of finalized delivery routes including the first finalized delivery route.

20. The computer system of claim 19, wherein the parsing further comprises associating the characteristic data with each of the plurality of nodes and with each of the plurality of edges, wherein the characteristic data comprises supplier characteristic data, processor characteristic data, and transport characteristic data.
